(19) United States
(12) Patent Application Publication
(10) Pub. No.: US 2003/0193308 A1
(43) Pub. Date: Oct. 16, 2003

(54) Apparatus and method for testing a motor-shorting relay

(76) Inventors: Gordon D. Richardson, Midland, MI (US); Steven Donald Klein, Munger, MI (US); Brian Lemanski, Linwood, MI (US)

Correspondence Address: EDMUND P. ANDERSON, DELPHI TECHNOLOGIES, INC., Legal Staff, Mail Code: 480-414-420, P.O. Box 5052, Troy, MI, 48007-5052, US

(21) Appl. No.: 10/123,437

(22) Filed: Apr. 16, 2002

(51) Int. Cl. H02P 1/46

(52) U.S. Cl. 318/700

(57) ABSTRACT

An apparatus for monitoring the operational condition of a relay configured for selective short-circuiting of the windings of a motor is disclosed. In an exemplary embodiment of the invention, the apparatus includes a current source connected to a first node in common with a first contact in the relay, and a second node in common with a second contact in the relay. A microprocessor provides an input signal to the current source. The input signal, when applied to the current source, causes the current source to apply a first voltage to the first node and a second voltage to the second node.

### TECHNICAL FIELD

The present invention relates generally to electric motors and control circuitry. More particularly, the present invention relates to a method and apparatus for testing the operability of motor damping and braking components such as electromagnetic relays.

### BACKGROUND OF THE INVENTION

Direct current (DC) brushless motors are synchronous machines having a permanently magnetized rotor free to rotate within fixed stator coils. Phased alternating currents passing through the stator coils generate a magnetic field that rotates the rotor. In certain applications using DC brushless motors, such as electric power steering systems, it may be necessary to rapidly stop the rotation of the motor. In order to achieve a rapid stopping or damping, the kinetic energy of the rotating motor shaft must be quickly dissipated. Once simple method of motor braking uses a mechanical brake in which friction, such as between brake pads and a rotating surface, dissipates the kinetic energy of the rotor as heat. Alternatively, dynamic braking takes advantage of the fact that a coasting DC motor acts like an electrical generator. In dynamic braking, a resistance is shunted across the stator windings, thereby allowing the energy of the coasting rotor to be converted to electrical energy and dissipated within the resistance as heat.

Electromagnetic relays are often used to provide a shorting capability for one or more stator windings of a DC brushless motor. A typical electromagnetic relay features an electromagnet which, when energized, attracts a moveable iron member to the core of the electromagnet. In turn, the moveable member may separate a moveable electrical contact from a stationary contact (or join a moveable contact to a stationary contact). An electromagnetic relay, being an electromechanical device, may be susceptible to wear and tear and hence may experience degraded performance.

In addition, arcing and frictional energies released during the switching of relay contacts can cause gases inside the relay to oxidize, resulting in carbon deposits on the contacts. Carbon deposits can increase the contact resistance and affect the damping operation of the relay, if used in such an application.

A need, therefore, exists for a apparatus and/or method that address the aforementioned concerns.

### SUMMARY OF THE INVENTION

The problems and disadvantages of the prior art are overcome and alleviated by an apparatus for monitoring the operational condition of a relay configured for selective short-circuiting of the windings of a motor. In an exemplary embodiment of the invention, the apparatus includes a current source connected to a first node in common with a first contact in the relay, and a second node in common with a second contact in the relay. A microprocessor provides an input signal to the current source. The input signal, when applied to the current source, causes the current source to apply a first voltage to the first node and a second voltage to the second node.

In a preferred embodiment, the relay further includes an electromagnetic coil energized by the microprocessor. The first and second contacts are normally closed when the electromagnetic coil is de-energized. The operability of the relay is determined, when the electromagnetic coil is de-energized, by comparing the first and second voltages after the input signal is applied to the current source. The relay is operable when the electromagnetic coil is de-energized if the first voltage equals said second voltage after the input signal is applied to the current source. In addition, the first and second contacts are normally opened when said electromagnetic coil is energized. The operability of the relay is further determined, when the electromagnetic coil is energized, by comparing the first and second voltages after the input signal is applied to the current source. The relay is operable when the electromagnetic coil is energized if the first voltage does not equal the second voltage after the input signal is applied to the current source.

### BRIEF DESCRIPTION OF THE DRAWINGS

The present invention will now be described, by way of example only, with reference to the accompanying drawings which are meant to be exemplary, not limiting, and wherein like elements are numbered alike in several Figures, in which:

FIG. 1 is a schematic diagram of an apparatus for monitoring the operational condition of a motor shorting relay, in accordance with an embodiment of the invention; and

FIG. 2 is a flow diagram illustrating a schematic diagram of a method for monitoring the operational condition of a motor shorting relay, in accordance with an embodiment of the invention.

### DESCRIPTION OF THE PREFERRED EMBODIMENT

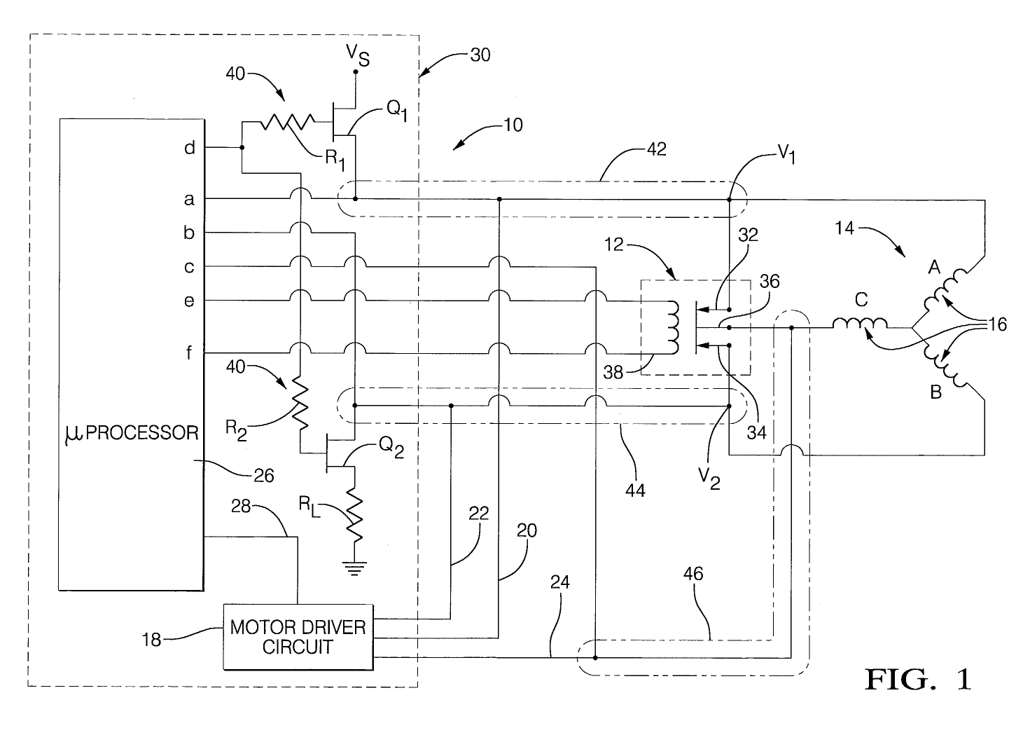

Referring initially to FIG. 1, there is shown a schematic diagram of an apparatus 10 for monitoring the operational condition of a motor shorting relay 12, in accordance with an embodiment of the invention. A motor 14 has a plurality of phase windings 16 associated therewith. Windings 16 are preferably located within a stator (not shown) of motor 14. In a preferred embodiment, the motor 14 is a brushless, direct current motor having three phase windings 16, designated by “A”, “B” and “C” in FIG. 1.

A motor driver circuit 18 provides the excitation current to the motor phase windings 16 through current carrying conductors 20, 22 and 24. The motor driver circuit 18 may provide a sinusoidal excitation input or a trapezoidal excitation input to phase windings 16. Generally, the excitation voltages generated by motor driver circuit 18 are 120 electrical degrees apart from one another in order to maximize torque performance of the motor 14. In addition to providing excitation current to windings 16, the motor driver circuit 18 also senses the current flowing in conductors 20, 22, 24 and provides feedback on the same to a microprocessor 26 through lead 28. Both the motor driver circuit 18 and the microprocessor 26 are located within a motor controller unit 30.

The motor shorting relay 12 is connected in parallel with the motor phase windings 16. In the embodiment shown, relay 12 has three separate, normally closed contacts 32, 34 and 36. Contacts 32 and 34 are moveable contacts, whereas contact 36 is a fixed or stationary contact. Each of the contacts is connected to a separate phase winding 16 of motor 14. The relay 12, being an electromagnetic relay, has an electromagnetic coil 38 or solenoid which, when energized causes normally closed contacts 32, 34 to open. The coil 38 is controlled and energized by microprocessor 26, shown schematically connected to pins “e” and “f” on the microprocessor. Thus configured, it will be seen that the coil 38 must remain energized in order for the motor 14 to run.

A current source 40 is also provided within motor controller unit 30 and is connected to relay contacts 32 and 34. The current source 40 includes a pair of FETs, Q₁ and Q₂, which have a pair of corresponding gate resistors, R₁ and R₂. Resistors R₁ and R₂ have a common input signal generated by the microprocessor, shown at pin “d”. A source voltage V_{S} is connected to the source terminal of Q₁, while the drain terminal thereof is connected to a first node 42. First node 42 is also common to phase winding “A”, relay contact 32, conductor 20 and pin “a” of microprocessor 26. The source terminal of Q₂ is connected to a second node 44, which is also common to phase winding “B”, relay contact 34, conductor 22 and pin “b” of microprocessor. Current source 40 also has a load resistor, R_{L}, connected between the drain terminal of Q₂ and ground.

The value of R_{L} determines the bias voltage applied to second node 44 (depending upon the position of the relay contacts 32, 34) when Q₂ is switched on. Finally, a third node 46 is common to phase winding “C”, contact 36, conductor 24 and pin “c” of microprocessor. As will be explained in further detail later, current source 40 provides a voltage across relay contacts 32 and 34 in order to test the operational condition of the relay 12. In addition, current source 40 also provides a low current pulse that serves to clean the relay contacts 32, 34 and 36 of any oxidized deposits formed thereupon.

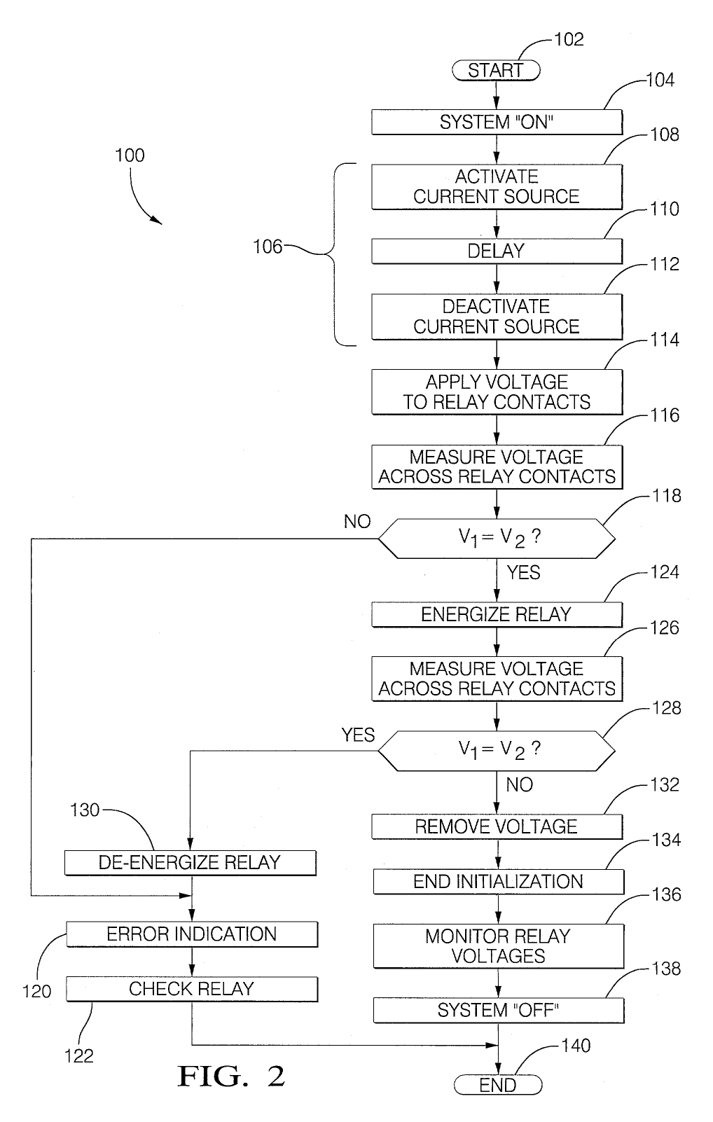

The operation of apparatus 10 will be understood by reference to FIGS. 1 and 2. FIG. 2 is a flow diagram, which illustrates a method 100 for monitoring the operational condition of a relay 12 (embodied in the example shown in FIG. 1). Method 100 begins at start block 102 and proceeds to block 104 where a system is activated or turned “on”. Again, by way of example only, the system may include an electric power steering system that provides a power steering assist to a steering rack (not shown) through motor 14.

In addition to determining the operational condition of the motor shorting relay 12, method 100 and apparatus 10 also perform a cleaning of the relay contacts 32, 34, 36. Thus, in FIG. 2, method 100 proceeds to a cleaning phase 106 prior to determining the operational condition of the relay 12. The cleaning phase begins at block 108, where the current source 40 is activated. Referring back to FIG. 1, an input signal sent from the microprocessor 26 (through pin “d”) to the gates of Q₁ and Q₂ causes Q₁ and Q₂ to be turned on, thereby creating a current path from V_{S} through the relay contacts 32, 34, 36, through R_{L} to ground. Because relay contacts 32, 34, 36 must be closed for current to flow therethrough, it follows that relay coil 38 is de-energized at this point. The magnitude of the current pulse will be determined by V_{S} and R_{L}. The source voltage V_{S} may be 12 volts, for example. Preferably, a low current pulse of 5 milliamps (mA) sent through the relay 12 assists in removing deposits on the contacts created by oxidation.

Method 100 continues at block 110 where a time delay is initiated such that the current can flow through contacts for a predetermined amount of time. Following the delay, method deactivates current source 40 at block 112. Next, method 100 proceeds to block 114, where the relay 12 is checked for proper operation in the closed position. Referring again to FIG. 1, this function is also accomplished by the application of an input signal to current source 40. Once again, Q₁ and Q₂ are switched on. As a result, a first voltage V₁ is applied to first node 42 from the drain terminal of Q₁, and a second voltage V₂ is also applied to second node 44 through the source terminal of Q₂. If the contacts are properly closed at this point, then V₁=V₂=V_{S}. Accordingly, method 100 thus proceeds to block 116 where the voltages V₁ and V₂ are measured and compared. If at decision block 118 it is determined that V₁=V₂, then the relay 12 is properly functioning in the normally closed position and the testing process may continue.

If, on the other hand, the relay contacts 32, 34, 36 were improperly open while the relay 12 were in a de-energized state, then V₁ would not equal V₂ due to an open circuit condition in the relay 12. In this situation, the voltage V₁ applied to first node 42 would be pulled up to V_{S} by Q₁, while the voltage V₂ applied at second node would be pulled to ground by Q₂. Thus, if it is determined at decision block 118 that V₁≠V₂, the relay is not functioning properly and method 100 then skips to block 120 where an error indication (not shown) may be given by microprocessor 26. At this point, the relay 12 should be checked (block 122) before restarting the entire process.

It should be pointed out that if the relay 12 were non-functional in the normally closed position (meaning the contacts 32, 34 were open), no current would have flowed through the relay during cleaning phase 106. Thus, it will easily be appreciated by those skilled in the art that the cleaning phase 106 represented by blocks 108, 110 and 112 may be performed after the testing functions represented by blocks 114, 116 and 118. In other words, the relay 12 could be tested in the closed position before any cleaning operation takes place.

Assuming that the relay contacts 32, 34 are properly closed when relay 12 is de-energized, method 100 then proceeds to block 124, where the relay coil 38 is then energized. If the relay 12 is working properly, contacts 32, 34 and 36 are then opened. Once again, V₁ and V₂ are measured and compared at block 126. If V₁=V₂, then the contacts have failed to open and decision block 128 routes the process to block 130 where the relay 12 is de-energized. Again, an error indication may be displayed at block 120 and the relay is then checked or inspected at block 122. If, however, V₁≠V₂, then the contacts have properly opened. The initial testing process is completed and current source 40 may be deactivated (blocks 132, 134) for normal operation of motor shorting relay 12 and motor 14.

Finally, method 100 may proceed to block 136 to monitor the operational status of relay 12 during the operation of the motor 14. Because the microprocessor 26 is connected to first, second and third nodes 42, 44, 46 by pins “a”, “b” and “c”, respectively, the microprocessor may continually monitor measured phase currents passing through windings 16. The measured phase currents at pins “a”, “b” and “c” are compared to the output state of the motor driver circuit 18 to verify that relay 12 is still open and the motor windings 16 have not been shorted. This monitoring process may be continued until the system is shut off at block 138 and the process ended at end block 140.

Through the foregoing description, it is seen that apparatus 10 and method 100 provide for the monitoring and testing of an electromagnetic relay, particularly a motor shorting relay used to damp or brake an electric motor by providing a short circuit path for the phase windings thereof. In the embodiments shown and described, a normally closed relay is used. However, it will easily be appreciated that a normally open relay may also be used.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An apparatus for monitoring the operational condition of a relay, the relay configured for selective short-circuiting of the windings of a motor, the apparatus comprising:
a current source, said current source connected to a first node, said first node in common with a first contact in the relay, and said current source connected to a second node, said second node in common with a second contact in the relay; and
a microprocessor, said microprocessor providing an input signal to said current source;
said input signal, when applied to said current source, causing said current source to apply a first voltage to said first node and a second voltage to said second node.

2. The apparatus of claim 1, wherein the relay further comprises:
an electromagnetic coil, said electromagnetic coil energized by said microprocessor.

3. The apparatus of claim 2, wherein said first and second contacts are normally closed when said electromagnetic coil is de-energized.

4. The apparatus of claim 3, wherein the operability of the relay is determined, when said electromagnetic coil is de-energized, by comparing said first and second voltages after said input signal is applied to said current source.

5. The apparatus of claim 4, wherein said relay is operable when said electromagnetic coil is de-energized, if:
said first voltage equals said second voltage after said input signal is applied to said current source.

6. The apparatus of claim 2, wherein:
said first and second contacts are cleaned of any oxidation deposits thereon by applying said input signal to said current source, while said electromagnetic coil is de-energized, thereby passing a low level current through said first and said second contacts.

7. The apparatus of claim 2, wherein said first and second contacts are normally opened when said electromagnetic coil is energized.

8. The apparatus of claim 7, wherein the operability of the relay is determined, when said electromagnetic coil is energized, by comparing said first and second voltages after said input signal is applied to said current source.

9. The apparatus of claim 8, wherein said relay is operable when said electromagnetic coil is energized, if:
said first voltage does not equal said second voltage after said input signal is applied to said current source.

10. A motor controller unit for a synchronous motor having a plurality of phase windings, the motor controller unit comprising:
a microprocessor;
a motor driver circuit, said motor driver circuit providing an excitation current to each of said plurality of phase windings, said motor driver circuit further providing motor current feedback information to microprocessor;
a motor shorting relay, connected in parallel with said plurality of phase windings, said motor shorting relay further comprising:
a plurality of contacts corresponding to each of said plurality of said phase windings, and
an electromagnetic coil energized by said microprocessor; and
a current source, driven by said microprocessor, said current source applying a voltage to at least two of said plurality of contacts.

11. The motor controller unit of claim 10, wherein:
said plurality of contacts are normally closed when said electromagnetic coil is de-energized and said plurality of normally closed contacts are opened when said electromagnetic coil is energized.

12. The motor controller unit of claim 1 1, wherein:
said plurality of contacts are cleaned of any oxidized deposits thereon by activating said current source when said contacts are closed.

13. A method for monitoring the operational condition of a relay, the relay configured for selective short-circuiting of the windings of a motor, the method comprising:
applying a first voltage to a first contact in the relay while the relay is de-energized;
applying a second voltage to a second contact in the relay while the relay is de-energized;
comparing said first and second voltages, while the relay is de-energized;
energizing the relay;
applying said first voltage to said first contact while the relay is energized;
applying said second voltage to said second contact while the relay is energized; and
comparing said first and said second voltages, while the relay is energized.

14. The method of claim 13, wherein the relay is configured in a normally closed state, and the relay is determined to be operational if:
said first and second voltages are equal when the relay is de-energized; and
said first and second voltages are not equal when the relay is energized.
